(19) United States
(12) Patent Application Publication
(10) Pub. No.: US 2008/0189099 A1
(43) Pub. Date: Aug. 7, 2008

(54) Customizable Delivery of Audio Information

(76) Inventors: Howard Friedman, New York, NY (US); Jeremy Friedman, New York, NY (US)

Correspondence Address: KATTEN MUCHIN ROSENMAN LLP, 575 MADISON AVENUE, NEW YORK, NY, 10022-2585, US

(21) Appl. No.: 11/813,132

(22) PCT Filed: Jan. 12, 2006
(86) PCT No.: PCT/US06/01126

§ 371 Date: Jun. 29, 2007

Related U.S. Application Data
(60) Provisional application No. 60/643,152, filed on Jan. 12, 2005.

(51) Int. Cl. G06F 17/20; G10L 13/00

(52) U.S. Cl. 704/8; 704/260; 704/E13.001

(57) ABSTRACT

A system for delivering customized audio content to customers. A central processing site (120) is coupled with content providers (110) through a network (142). The central processing consists of a number of components, namely content classification system (200), user preference management (400), content conversion system (500), content delivery system (600), and user authentication (300).

### RELATED APPLICATION

This application claims priority to U.S. Provisional Application No. 60/643,152 filed Jan. 12, 2005, which is incorporated by reference herein in its entirety.

### TECHNICAL FIELD

The present invention relates generally to the field of delivering audio content to users. More specifically, the present invention is related to customizing the delivery of audio content which is derived from textual content obtained from content providers.

### BACKGROUND OF THE INVENTION

Being able to deliver customizable audio content to a user is gaining importance in the marketplace. Various solutions exist in the marketplace which provide audio content to users. For example, online news providers providing news in textual form from sources such as, original news (e.g., BBC, CNN), periodicals (e.g., Wall Street Journal, New York Times, etc.), and online news aggregators (e.g., Google news, Yahoo news, etc.) present online customers with a selection of news based on user defined preferences. These text articles can be: delivered via email to the user, displayed on the user's browser for user controlled viewing and/or download, or streamed to a device associated with the user.

Currently, one of the common applications for downloadable audio is digital music, which is provided by players such as iTunes®, Rhapsody®, Napster®, RealNetworks®, and WalMart®. Another application of audio distribution is online audio books, newspapers, and magazines. Audible™ is currently a large distributor of such audio information.

Audible's periodical product is a downloadable audio recording of a human reading an abridged version of a newspaper or of a magazine. Audible's production cycle generally consists of the following steps: receiving a text version of the periodical, subjectively editing out content for the purpose of time consolidation, handing off the abridged content to a reader, recording an individual reading the content to produce an audio file of the abridged content, then finally making the content deliverable. The final product is delivered to the user as one large .aa (audible audio) file to be downloaded onto a portable device which is “audible ready”. “Audible ready” refers to a subset of portable audio devices that support this proprietary digital audio format. The entire periodical must be downloaded as one large .aa file which consists of sub-sections. The sub-sections allow the user to jump to different sections of the newspaper after they have downloaded the entire audio file.

The use of a human reader in Audible's product limits the delivery of audio files to only articles for which Audible has previously used a reader to create the audio files. Thus, the use of a human reader makes the creation of user-initiated audio files difficult as a reader would need to be available to read the desired text on demand. The use of a human reader also limits the number of audio, content selection and delivery options that can be provided to the user. Audible's product does not have the process or technology for performing foreign language translation.

The following references generally describe various systems and methods used in the distribution of audio content to users.

The patent to Lau et al. (U.S. Pat. No. 5,790,423), assigned to Audible, Inc., provides for Interactive Audio Transmission Receiving and Playback System. Discussed is a service center including an electronic user accessible interface and library of stored user selectable programs. The selected programs are recorded onto a cassette. However, Lau et al. fail to discuss, a plurality of content providers providing textual content, disaggregating of the textual content, tagging of disaggregated content units, automated conversion of textual content unit to audio files and providing users with options regarding audio preferences, audio format preferences, playback order preferences or delivery method preferences.

The patent to Tjaden (U.S. Pat. No. 5,915,238) provides for a Personalized Audio Information Delivery System. Discussed is master controller that is linked to a plurality of information providers. Remote information collection application collects and stores information items in textual form, which are received from a plurality of information providers. The “categorize and edit” application accesses the raw information item file, a category file, and an edited information file in order to assign categories to and edit raw information items collected and stored by the remote information collection application. However, the Tjaden reference fails to discuss, automatically converting textual content units at a central processing site into audio files, and providing users with options regarding audio preferences, audio format preferences, playback order preferences or delivery method preferences.

The patent to Mott et al. (U.S. Pat. No. 6,170,060 B1), assigned to Audible, Inc., provides for a Method and Apparatus for Targeting a Digital Information Playback Device. Discussed is a digital information library system providing selection of digital information programming such as books, news, and entertainment feeds etc., on demand over a computer network. An authoring system is used to edit, index, compress, scramble, segment, and catalog digital information programs in digital information files wherein these files are stored in a library server. Assignee related patents U.S. Pat. No. 6,560,651 B2 and U.S. Pat. No. 5,926,624 also discuss similar features. However, these references fail to discuss, a plurality of content providers providing content, automatically converting textual content units to audio files, disaggregating of the content, and providing options to users regarding audio preferences, audio format preferences, playback order preferences or delivery method preferences.

The patent to Story et al. (U.S. Pat. No. 6,253,237 B1), assigned to Audible, Inc., provides for Personalized Time-Shifted Programming. Discussed is a library which stores digital content for subsequent playback in a personalized time-shifted manner. However, Story et al. fail to discuss, a plurality of content providers providing textual content, disaggregating of the textual content, tagging of disaggregated content units, automated conversion of textual content unit to audio files and providing users with options regarding audio preferences, audio format preferences, playback order preferences or delivery method preferences.

The patent to Lumelsky (U.S. Pat. No. 6,246,672 B1), assigned to International Business Machines Corporation, provides for a Single cast Interactive Radio System. Discussed is personal radio station server (PRSS) that stores multiple subscribers' profiles with topics of individual interest, assembles content material from various Web sites according to the topics, and transmits the content to a subscriber's user terminal. The user terminal plays the material back as a computer-generated speech using text-to-speech with transplanted prosody using one of several preloaded voices. However, the Lumelsky reference fails to discuss, disaggregating of the textual content, tagging of disaggregated content units, and providing users with options regarding, audio format preferences, playback order preferences or delivery method preferences.

The patent to Rajasekharan et al. (U.S. Pat. No. 6,480,961 B2), assigned to Audible, Inc., provides for Secure Streaming of Digital Audio/Visual Content. Discussed is a method of securely streaming digital content wherein a check is performed to determine if a playback device is authorized to play the content. However, Rajasekharan et al. fail to discuss, a plurality of content providers providing textual content, disaggregating of the textual content, tagging of disaggregated content units, automated conversion of textual content unit to audio files and providing users with options regarding audio preferences, audio format preferences, playback order preferences or delivery method preferences.

The patent to Zimgibl et al. (U.S. Pat. No. 6,964,012 B1), assigned to MicroStrategy, Incorporated, provides for a System and Method for the Creation and Automatic Deployment of Personalized, Dynamic and Interactive Voice Services, Including Deployment through Personalized Broadcasts. Discussed is a system that creates and automatically deploys a personalized, dynamic and interactive voice service, including information from on-line analytical processing systems and other data repositories. Personalization of the delivery format may include selection of style properties that determine the sex of the voice and the speed of the voice. However, Zimgibl et al. fail to discuss, a plurality of content providers providing textual content, disaggregating of the textual content, tagging of disaggregated content units, and providing users with options regarding, audio format preferences, playback order preferences or delivery method preferences.

The patent application publication to Tudor et al. (2002/0059574 A1) provides for a Method and Apparatus for Management and Delivery of Electronic Content to End Users. Discussed is a content delivery platform which includes a series of modules that send requested electronic content to an end user based on user preferences. However, Tudor et al. fail to discuss, a plurality of content providers providing textual content, disaggregating of the textual content, tagging of disaggregated content units, automated conversion of textual content unit to audio files and providing users with options regarding audio preferences, audio format preferences, playback order preferences or delivery method preferences.

The patent application publication to Spitzer (2003/0009343 A1), assigned to SnowShore Networks, Inc., provides for a System and Method for Constructing Phrases for a Media Server. Discussed is a method of delivering prompts and variable data rendered in audio form to a user. However, the Spitzer reference fails to discuss, a plurality of content providers providing textual content, disaggregating of the textual content, tagging of disaggregated content units, automated conversion of textual content unit to audio files and providing users with options regarding audio preferences, audio format preferences, or delivery method preferences.

The patent application publication to Yogeshwar et al. (2003/0210821 A1), assigned to Front Proch Digital Inc., provides for Methods and Apparatus for Generating, Including and Using Information Relating to Archived Audio/Video Data. Discussed is a method of retrieving audio/image data wherein captured data is catalogued and indexed at or subsequent to creation of an intermediate archive format file which includes the archived encoded data. The encoding format to be used is determined from information provided by the user. Assignee related patent application publication US2004/0096110 A1 also discusses similar features. However, Yogeshwar et al. fail to discuss, a plurality of content providers providing textual content, disaggregating of the textual content, tagging of disaggregated content units, automated conversion of textual content unit to audio files and providing users with options regarding audio preferences, playback order preferences or delivery method preferences.

The patent application publication to Leaning et al. (2004/0064573 A1) provides for Transmission and Reception of Audio and/or Video Material. Discussed is a method of playing audio/video material stored on a remote server as a set of files representing successive temporal portions of the material. However, Leaning et al. fail to discuss, a plurality of content providers providing textual content, disaggregating of the textual content, tagging of disaggregated content units, automated conversion of textual content unit to audio files and providing users with options regarding audio preferences, audio format preferences, playback order preferences or delivery method preferences.

U.S. Pat. Nos. 5,721,827; 6,055,566 and 6,970,915 B1 describe systems that aggregate information items and convert text items into speech (usually with human intervention). These references also fail to provide the receiving of aggregate information from a plurality of content providers and automatically converting the textual information into audio files.

The articles “Free Text-to-Speech Technologies”, “MobileMedia Suite Details”, “Taldia: Personalized Podcasting”, and “The Power of Spoken Audio”, describe commercial systems that collect information (news, weather, business, etc.) and convert the items into audio files for personalized delivery to users. However, these articles fail to discuss, disaggregating of textual content from a plurality of content providers, tagging of disaggregated content units, automated and providing users with options regarding audio preferences, playback order preferences or delivery method preferences.

Whatever the precise merits, features, and advantages of the above cited references, none of them achieves or fulfills the purposes of the present invention.

### DISCLOSURE OF INVENTION

The present invention provides for a method to customize delivery of audio content to one or more clients, the audio content derived from textual content obtained from one or more content providers, the method comprising the steps of: identifying textual content based on pre-stored content preferences or user content selections associated with a client; receiving and disaggregating identified textual content into one or more content units based on predefined content classification; automatically converting the disaggregated content units into one or more audio files based on audio preferences and audio format preferences; and delivering the one or more audio files to the client in (a) based on at least delivery method preferences.

The present invention provides for a central processing site to customize delivery of audio content to one or more clients, the audio content derived from textual content obtained from one or more content providers, the central processing site comprising: a) a user preferences management component storing at least the following preferences: content preferences, delivery method preferences, audio preferences, and audio format preferences; b) a content classification component comprising a library storing content classifications and a storage storing textual content disaggregated into one or more content units based on the content classifications, wherein the textual content is identified based on the content preferences or user content selections associated with a client; c) a content conversion component automatically converting the disaggregated content units into one or more audio files based on the audio preferences and the audio format preferences; and d) a content delivery component delivering the one or more audio files to the client in (b) based on at least the delivery method preferences.

The present invention provides for an article of manufacture comprising a computer readable medium having computer readable program code embodied therein which implements a method to customize delivery of audio content to one or more clients, the audio content derived from textual content obtained from one or more content providers, the medium comprising: a) computer readable program code identifying textual content based on pre-stored content preferences or user content selections associated with a client; b) computer readable program code aiding in receiving said identified textual content; c) computer readable program code disaggregating said received textual content into one or more content units based on predefined content classification; d) computer readable program code automatically converting the disaggregated content units into one or more audio files based on audio preferences and audio format preferences; and e) computer readable program code aiding in delivering the one or more audio files to the client in (a) based on at least delivery method preferences.

### DESCRIPTION OF THE DRAWINGS

### Brief Description of the Drawings

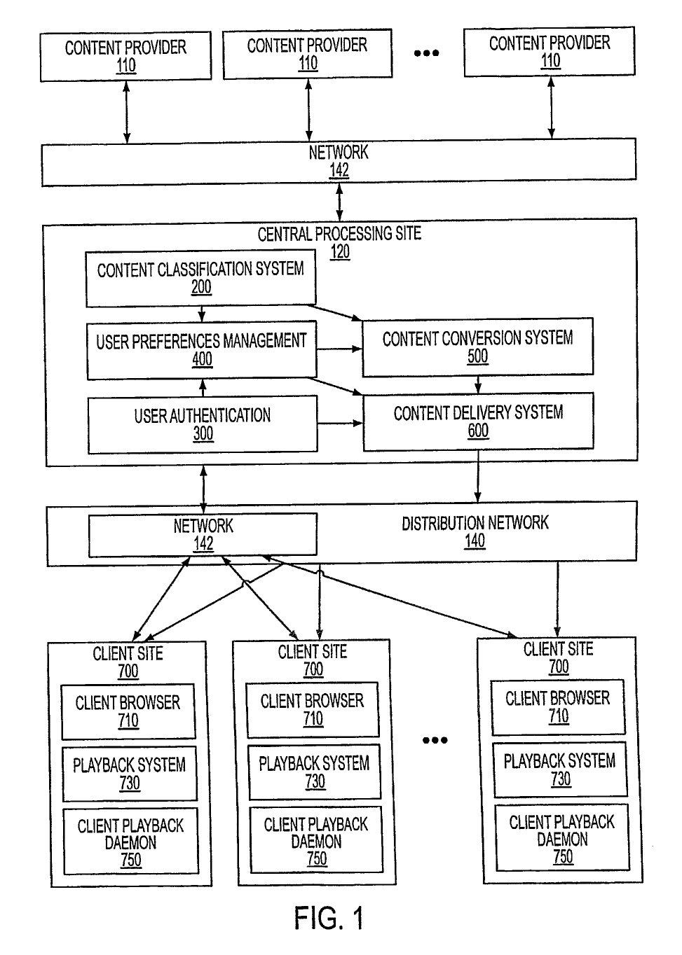

FIG. 1 illustrates various components of the system for delivering customizable audio content to customers/users, as per the present invention.

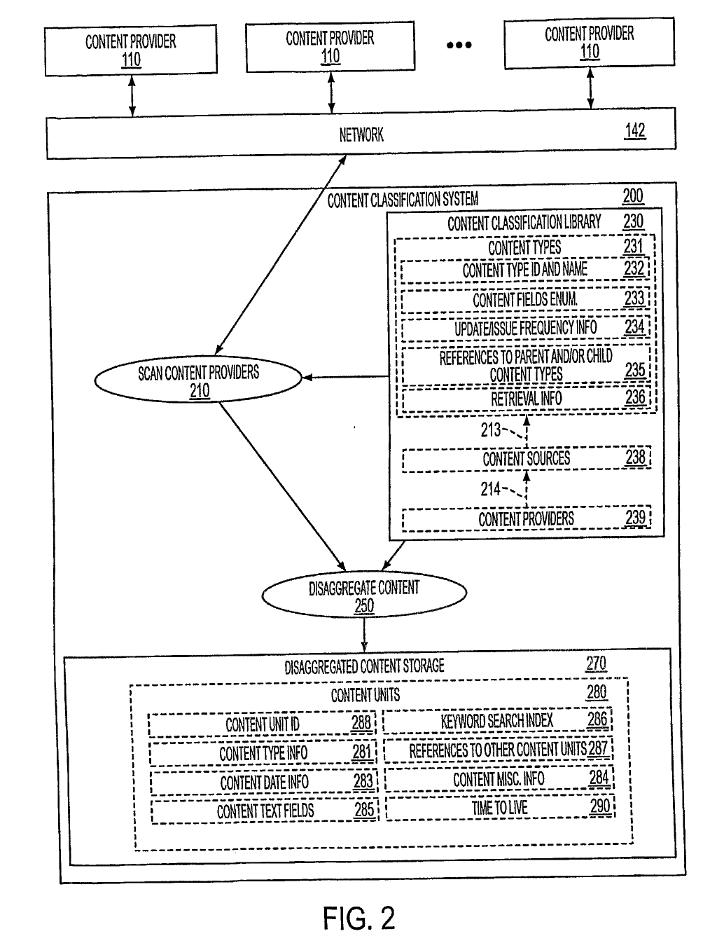

FIG. 2 illustrates subsystems of the content classification system, as per the present invention.

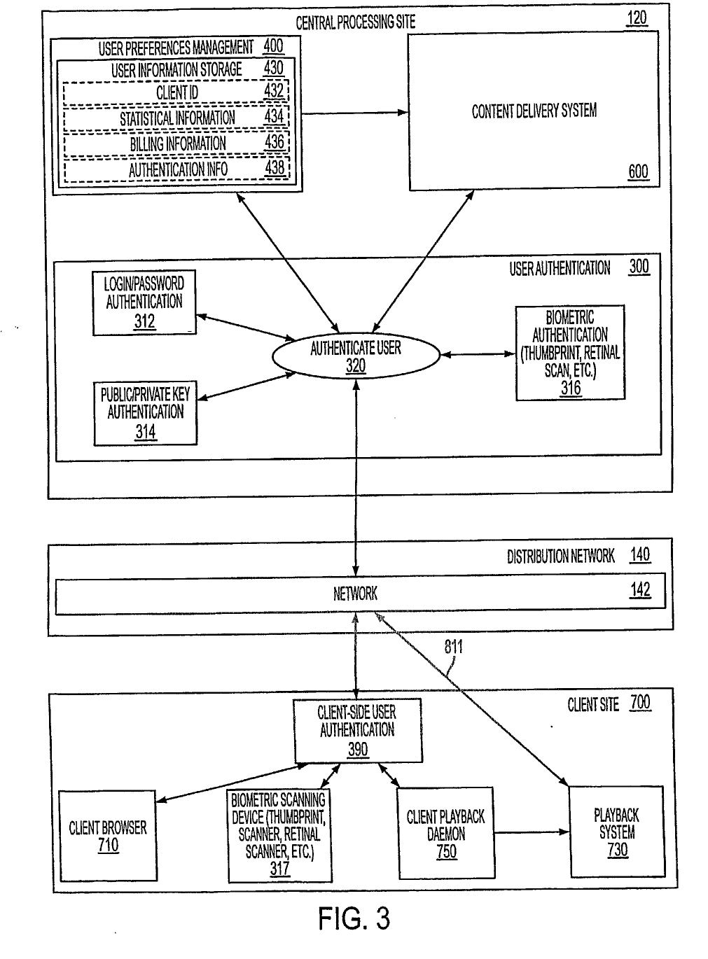

FIG. 3 illustrates subsystems of the User Authentication component, as per the present invention.

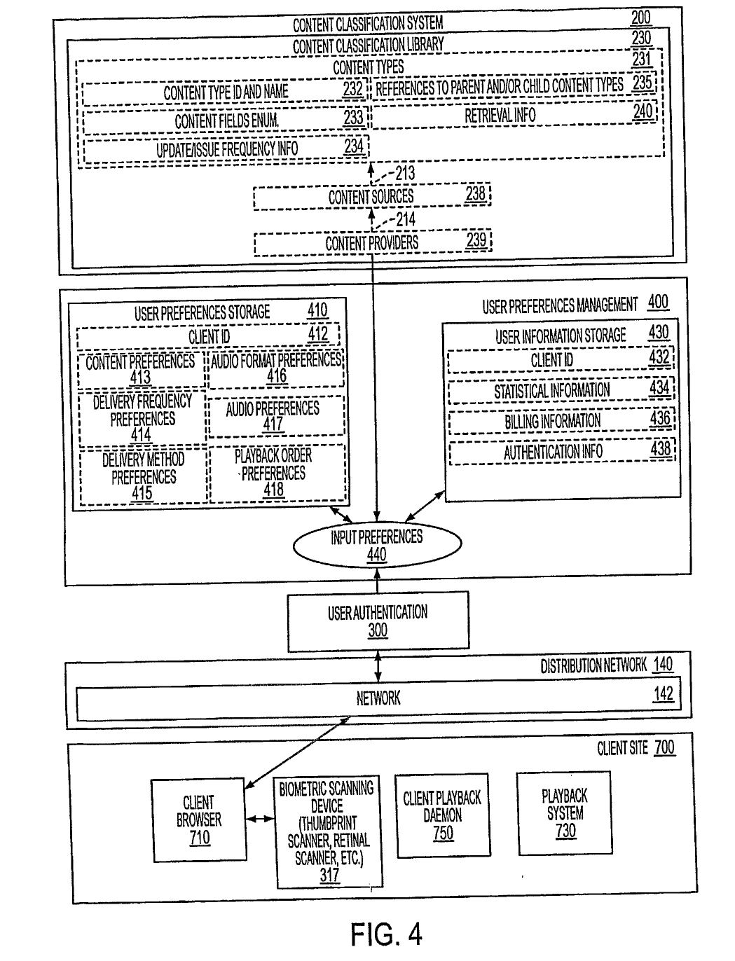

FIG. 4 illustrates subsystems of the User Preference Management component, as per the present invention.

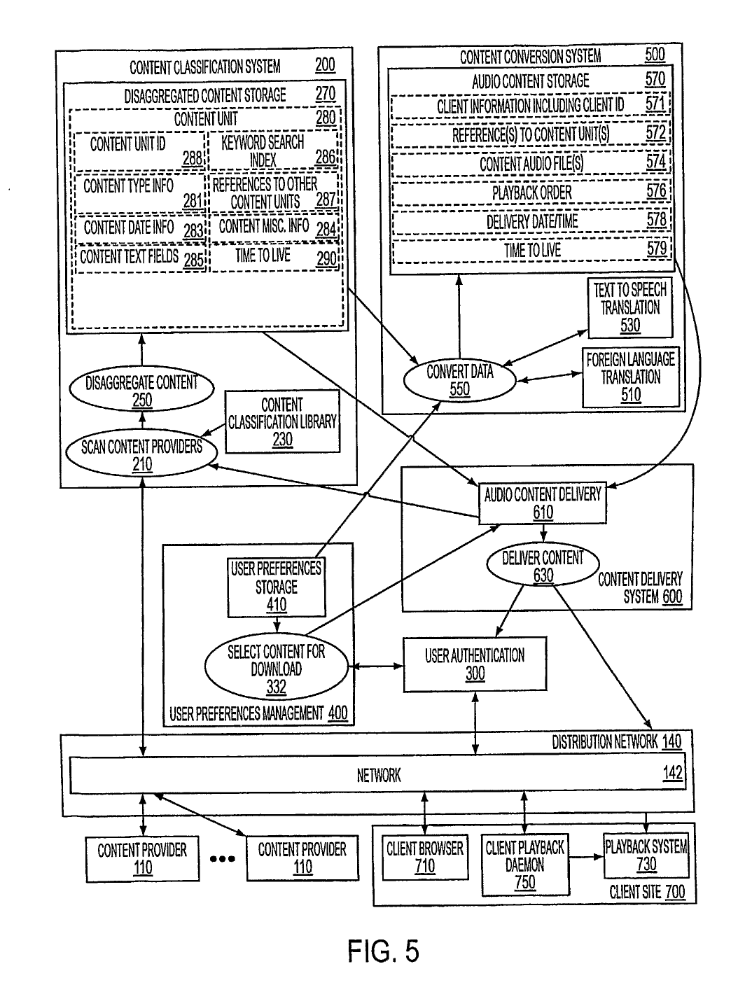

FIG. 5 illustrates a preferred embodiment of the present invention for delivering customizable audio content to customers/users.

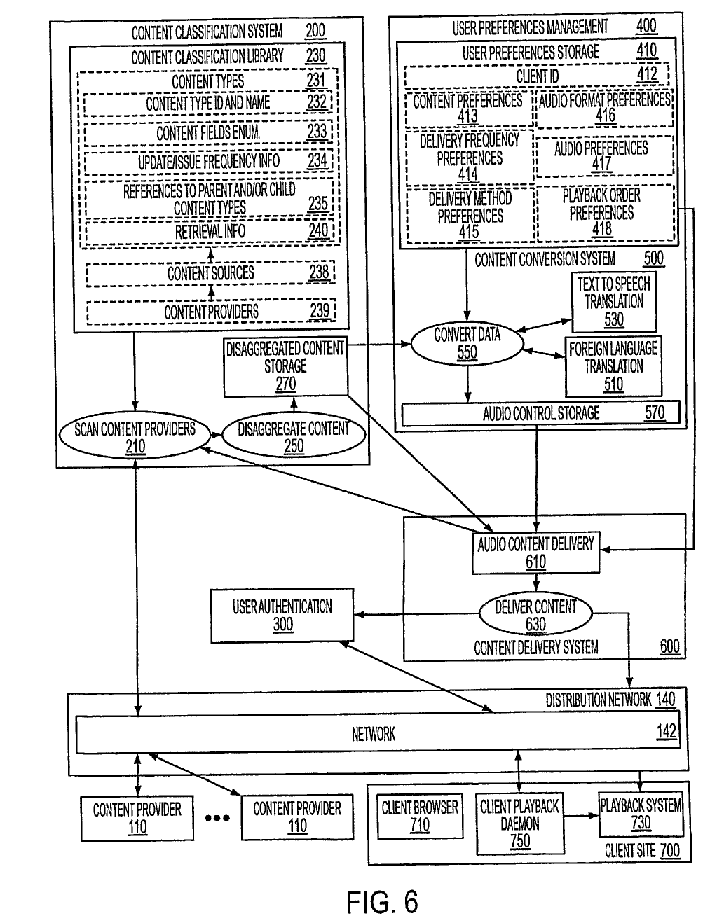

FIG. 6 illustrates another embodiment of the present invention for delivering customizable audio content to customers/users.

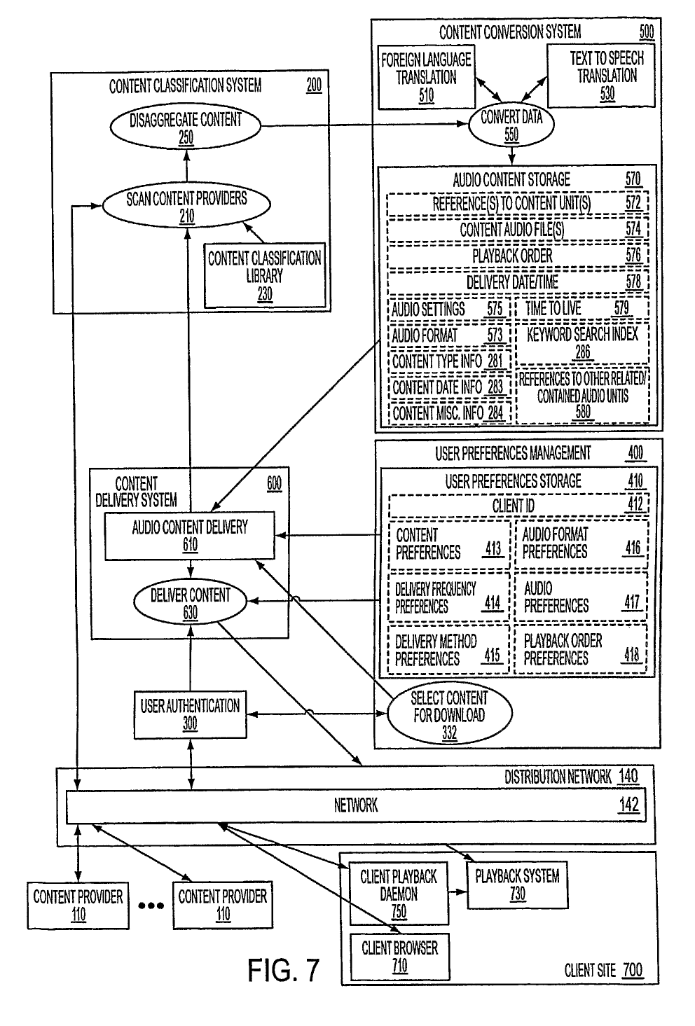

FIG. 7 illustrates yet another embodiment of the present invention for delivering customizable audio content to customers/users, as per the present invention.

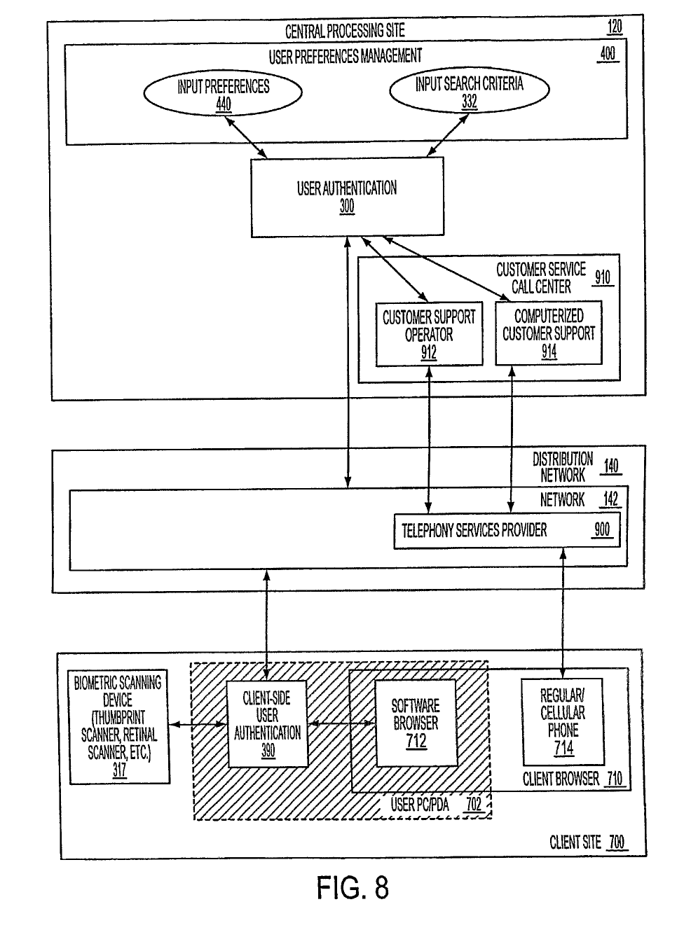

FIG. 8 illustrates subsystems of the Client Site, as per the present invention.

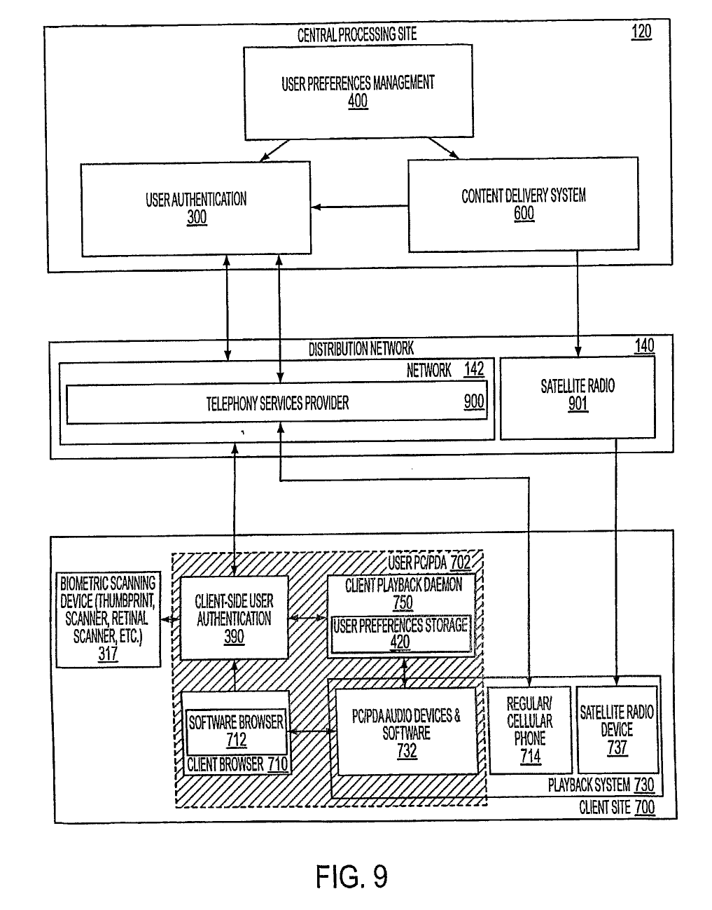

FIG. 9 illustrates additional subsystems of the Client Site, as per the present invention.

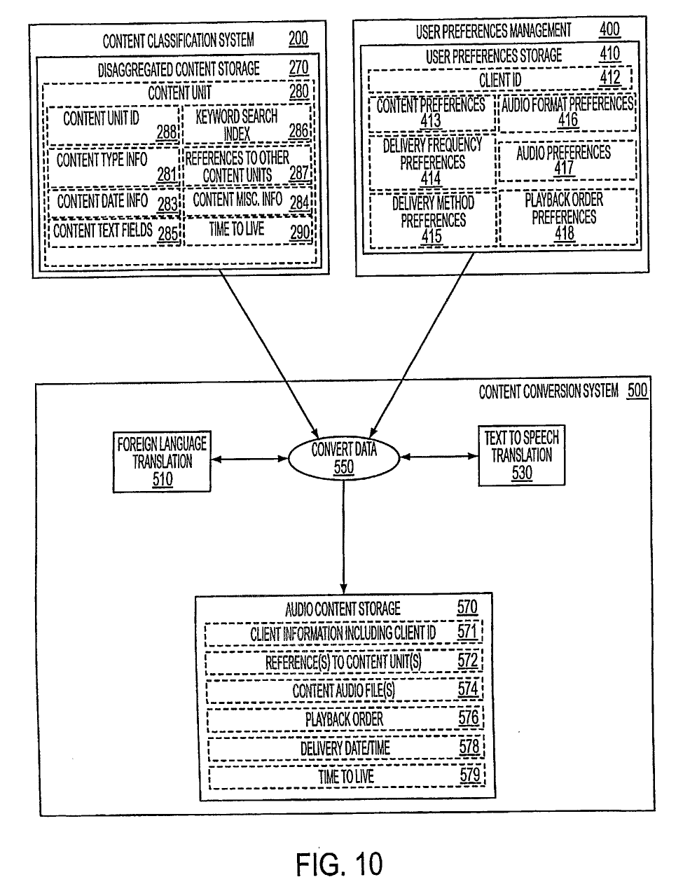

FIG. 10 illustrates subsystems of the Content Conversion System, as per the present invention.

### BEST MODE FOR CARRYING OUT THE INVENTION

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

FIG. 1 illustrates various components of the system for delivering customizable audio content to customers/users, as per the present invention. Central Processing Site 120 is one of the core components of the present invention. Central Processing Site 120 is coupled with the Content Providers 110 through Network 142. Content Providers are entities that provide textual content in any digital format. The textual content provided by these content providers includes, but is not limited to, magazines, newspapers, RSS feeds, books and weblogs. Network 142 is any digital network capable of transmitting data in both directions such as a Local Area Network (LAN); an Internet network implemented: over standard telephone network, over Integrated Services Digital Network (ISDN), over cable network, over optical fiber, over Digital Subscriber Line (DSL) technologies, over wireless technologies; a proprietary network such as America Online (AOL®) or CompuServe®; or wireless networks operating over GSM/GPRS. Network 142 may also be a combination of any of these technologies and is not limited to these technologies.

Central Processing Site 120 is coupled with Client Sites 700 through Distribution Network 140. Distribution Network 140 may also include, but is not limited to, any of the delivery mechanisms used in Network 142 as well as any one-way communications networks, such as satellite-radio. The audio content is delivered to the Client Sites 700 by any means provided by the Distribution Network 140.

Central Processing Site 120 consists of a number of components, namely Content Classification System 200, User Preference Management 400, Content Conversion System 500, Content Delivery System 600 and User Authentication 300. These components may all reside on a single workstation or server or may be distributed on different machines or servers and coupled through the Network 142. Moreover, each component may reside on one workstation or server, or on different workstations or servers; for example, data storages of all these components may reside on one server while processes that use these storages may all reside on another server.

Client Sites 700 represent customers with their audio devices (PC, phone, satellite-radio, etc.). Client Browser 710 is an application implemented using software or hardware, wherein customers use the Client browser 710 to interact with the Central Processing Site via Distribution Network 140. Client Browser 710 may consist of a web-browser based application, a web-enabled desktop application or proprietary non-web technology for remote communications. Playback System 730 is a set of audio devices and software that allow playing back digital audio files. Client Playback Daemon 750 is a software application that can automatically download and play the audio from the Central Processing Site 120 based on the user's preferences regarding content elements, delivery frequencies, delivery methods, audio format, language and playback order. However, in one embodiment, Client Browser 710 and Playback System 730 includes or is completely replaced by non-software components, for example, Client Browser 710 consists of a cellular phone which interacts with Central Processing Site 120.

FIG. 2 illustrates subsystems of content classification system 200, as per one embodiment of the present invention. Content Classification Library 230 and Disaggregated Content Storage 270 are contained in the Content Classification System 200. These two subsystems retrieve, classify and store textual content, which is later converted into audio. Content Classification Library 230 is data storage maintained by the Central Processing Site administrators. Disaggregated Content Storage 270 is a repository for content that is retrieved from Content Providers 110 and disaggregated into Content Units 280.

The data within the Content Classification Library 230 may be predefined and maintained by a dedicated administration staff. Content Providers Information 239 stores information about each particular Content Provider 110, including statistical data such as names, company, address, etc., as well as information about how to connect to the Content Providers 110 in order to retrieve textual content; for example, an IP address, a URL to a web-service that outputs content etc. This information is used by Scan Content Providers 210 to connect to Content Providers 110. Also, information regarding Content Providers 110 will be updated using an appropriate timing and control mechanism, or on an as-needed basis to ensure the success of transmission of data between Content Providers 110 and Content Classification System 200.

Content Sources 238 represent sources of textual content, i.e. newspapers, magazines, RSS feeds, etc. Each Content Source has its own intrinsic structure of content which needs to be described in the Content Classification Library 230 in order to allow users to search within and subscribe to certain portions of Content Sources 238. For example, a newspaper may consist of a collection of individual articles; a web-site may consist of a set of RSS feeds which consist of topics that further consist of articles/pages. Content Classification Library 230 determines the levels of data disaggregation for each specific content source. A content source may change its structure over time. This information about the content source's structure will be updated with an appropriate timing and control mechanism, or on an as-needed basis to ensure the success transmission of data between Content Providers 110 and Content Classification System 200. A historical record of the content source's structure may be stored for purposes of retrieving archival records where the content source structure may have been changed.

Content Types 231 component of Content Classification Library 230 stores information regarding different content sources such as newspapers, articles etc. A logical connection between Content Sources 238 and Content Types 231 is demonstrated by arrow 213. This arrow represents a relationship between Content Sources 238 and Content Types 231, such that each Content Source 238 should be described by a set of Content Types 231. Each of Content Types 231 stores its name and ID in Content Type ID and Name 232, and enumeration of content fields in Content Fields Enum 233. Content Fields for content sources at each level of hierarchy are different; for example, an article would have Title, Author and Body Text fields, while a Newspaper Section would have Name, Editor and Topic fields; a business related article may have topic fields which include the industry of the business, company names, and stock ticker identification. Update/Issue Frequency Info 234 denotes how often the content is updated at a level so that Central Processing Site 120 can automatically retrieve content updates when necessary and send them to the customers. References to Parent and/or Child Content Types 235 establish the hierarchy of content types within a content source. A content type would be a parent for another content type if instances of the former logically contains instances of the latter; for example a Newspaper Section Content Type would be parent for a Newspaper Article Content Type because actual newspaper sections consist of newspaper articles; and conversely, a Newspaper Article Content Type would be a child of a Newspaper Section Content Type. References to Parent and/or Child Content Types 235 uses content types' names and/or IDs specified in Content Type ID and Name 232 to store references to parent and/or child content types for each Content Type 231. Retrieval Info 236 may store other information required by Scan Content Providers 210 in order to successfully retrieve the content from Content Providers 110 for each Content Type 231; for example, this information may be a web service's address which the Scan Content Providers 210 would access to retrieve the data. Retrieval Info 236 may not always be required for each content type, for certain content sources, or for certain content providers. Also, Retrieval Info 236 may include a phone number for technical support, or any other information necessary for the administration staff.

Content Classification Library 230 stores relationship between Content Providers 239 and Content Sources 238 as demonstrated by arrow 214. Arrow 214 represents a logical connection between Content Providers 239 and Content Sources 238 such that Scan Content Providers 210 know which content sources are provided by each content provider. Once a Content Source is entered, the Content Types for it are defined and a relationship with the Content Provider established.

Scan Content Providers 210 is a component that is responsible for retrieving the content from the providers registered in the Content Classification Library 230. The scanning process of Scan Content Providers 210 may be started on request from a user wanting to search for content, may be regularly started according to a predefined schedule for each or all content sources, may be notified by Content Providers 110 that there are updates of the content which can be retrieved, or Content Providers 110 may transmit new content right away along with the notification. Scan Content Providers 210 may scan all content providers for updates to all content sources, or selectively only scan specific content providers for specific content sources. The data retrieved by Scan Content Providers 210 from Content Providers 110 is redirected to the Disaggregate Content 250 component, which disaggregates the data into specific Content Units 280 in Disaggregated Content Storage 270. Scan Content Providers 210 and Disaggregate Content 250 processes may reside on the same workstation or server, reside on different workstations or servers; or may even be implemented as parts of the same process.

Disaggregated Content Storage 270 stores the disaggregated textual content in Content Units 280. Content Units 280 represent specific pieces of content of a specific issue of a specific content source. Content Units 280 may represent the smallest indivisible units of information as well as bigger divisible units of information. The level of disaggregation of the Content Units 280 depends on the information stored in the Content Classification Library 230. Examples of Content Units 280 may include: a certain issue of a newspaper, a certain section of a certain issue of a newspaper, a certain article of a certain section of a certain issue of a newspaper.

Disaggregate Content component 250 disaggregates information/content received from content providers into Content Units 280 according to the classification set by Content Classification Library 230. Content Units 280 store the following information to reconstruct original information received from content providers:
Content Unit ID 288 is a unique ID of a Content Unit; Content Unit IDs are used to reference content units from References to other Content Units 287
Content Type Info 281 is a reference to Content Types 231 and specifies what type of content the Content Unit represents
Content Date Info 283 specifies the date of the content issue which allows for identification of the content issue in future data searches
Content Text Fields 285 store the actual values for the fields germane to this specific Content Unit as specified by the Content Fields Enum 233; these fields store the actual textual content; for example, a newspaper article content unit would have Title, Author and Box text fields filled in with actual textual content. Content Text Fields 285 later get converted into audio and delivered to the users
Keyword Search Index 286 is a collection of data used for Keyword searches, this index is generated from the values in Content Text Fields 285; in other words, content units are tagged with keywords such that content can be customized using a keyword search
References to other Content Units 287 stores references to parent and/or child Content Units and allow for reconstructing the hierarchy of actual content of a certain issue of a certain Content Source; it also allows for referencing other Content Units which are related to this Content Unit and may even belong to different Content Sources; information about the related content may be provided by Content Providers 110 or inputted by the Central Processing Site staff

The data stored in Disaggregated Content Storage 270 may be stored indefinitely, may remain stored for a pre-defined set of time before being either erased or archived; or may even be erased as soon as it has been converted to audio and delivered to a destination audience. Time-to-Live 290 denotes this value for each Content Unit 280. Content Miscellaneous Information 284 is storage for miscellaneous information about the Content Unit that does not fall into one of the above listed fields and may contain the data for internal purposes specific to various embodiments of the present invention.

The information stored in Content Types 231 of Content Classification Library 230 and Content Units 280 of Disaggregated Content storage 270 is illustrated via an example provided below:

Specifically, the first example describes how a New York Times newspaper can be described in the Content Classification Library 230 and how a specific issue of this newspaper can be described in the Disaggregated Content Storage 270. Assuming that the New York Times is a daily newspaper with two columns—a “News” column consisting of “International” and “Business” sections and a “Features” column consisting of “Arts” and “Books”—and that a business news article named “Alltel to Spin Off Land-Line Phone Unit” was published in the New York Times newspaper on Dec. 9, 2005; the Content Types 231 required to classify The New York Times Content Source can be as presented in table 1.1 below:

TABLE 1.1
Content Types 231 for The New York Times Content source

| Content Type | | | References to Parent |
|---|---|---|---|
| ID and | Content Fields | Update/Issue | and/or Child Content |
| Name | Enum. | Frequency Info | Types |
| 232 | 233 | 234 | 235 |
| 1. “Entire | Issue # | Daily | Child: 2 |
| Newspaper” | | | |
| 2. “Column” | Name | n/a | Parent: 1 |
| | | | Child: 3 |
| 3. “Section” | Name | n/a | Parent: 2 |
| | | | Child: 4 |
| 4. “Article” | Title, Authors, | n/a | |
| | Body Text | | |

References to Parent and/or Child Content Types 235 establish the hierarchy of Content Types within the New York Times content source. In this example, the “Entire Newspaper” content type is the parent of the “Column” content type—this is denoted by referencing the Content Type with ID 2 in the Child reference of the “Entire Newspaper” content type, and by referencing the Content Type with ID 1 in the Parent reference of the “Column” content type. The other Child and Parent references establish the hierarchy in this same way. Thus, this example states that content instances of the “Entire Newspaper” content type consist of content instances of the “Column” content type, which in turn consist of content instances of the “Section” content type, which in turn consist of content instances of the “Article” content type.

The content units of the Dec. 9, 2005 issue of The New York Times Content Source can be as presented as shown in table 1.2 below:

TABLE 1.2
Content Units 280 for the Dec. 9, 2005 issue of The New York Times
Content Source

| | | | | Ref. to | |
|---|---|---|---|---|---|
| | | | Content | other | Keyword |
| Content | Content | | Date | Content | Search |
| Unit ID | Type Info | Content Text Fields | Info | Units | Index |
| 288 | 281 | 285 | 283 | 287 | 286 |
| 1 | 1. “Entire | Issue# = 1234 | Dec. 9, 2005 | | |
| | Newspaper” | | | | |
| 2 | 2. | Name = “News” | Dec. 9, 2005 | Parent = 1 | |
| | “Column” | | | | |
| 3 | 2. | Name = “Features” | Dec. 9, 2005 | Parent = 1 | |
| | “Column” | | | | |
| 4 | 3. “Section” | Name = “International” | Dec. 9, 2005 | Parent = 2 | |
| 5 | 3. “Section” | Name = “Business” | Dec. 9, 2005 | Parent = 2 | Alltel |
| | | | | | sorkin |
| | | | | | belson |
| | | | | | AT |
| 6 | 3. “Section” | Name = “Arts” | Dec. 9, 2005 | Parent = 3 | |
| 7 | 3. “Section” | Name = “Books” | Dec. 9, 2005 | Parent = 3 | |
| 8 | 4. “Article” | Title = “Alltel to Spin Off | Dec. 9, 2005 | Parent = 5 | alltel |
| | | Land-Line Phone Unit” | | | sorkin |
| | | Authors = ANDREW ROSS | | | belson |
| | | SORKIN, KEN BELSON | | | AT |
| | | Body Text = “Alltel, the | | | |
| | | nation's largest rural | | | |
| | | telephone company, said | | | |
| | | today it would spin off its | | | |
| | | land-line unit and merge it | | | |
| | | with Valor . . . ” | | | |

Note that the columns and sections generally do not change frequently for a given newspaper; an embodiment of the invention optimizes the content units storage and generally does not duplicate the Column and Section Content Units each day.

In this example, the Keyword Search Index 286 is filled in for the smallest indivisible Content Unit with the ID 8 as well as for the Content Unit with the ID 5. Content Unit 8 is logically contained within Content Unit 5. Content Unit 5's Keyword Search Index 286 aggregates the Keyword Search Indexes of all its children (in this case there is one child) and thus, if the user performs the keyword search with the keyword “belson” he/she will find both the specific article to which the Content Unit 8 corresponds, and the whole Business Column, to which the Content Unit 5 corresponds. In other embodiments, the Disaggregated Content Storage 270 stores Keyword Search Index 286 for only the smallest indivisible content units. In that case, the Content Unit 5 would not have the keyword search index. “AT” in the Keyword Search Index 286 represents the stock ticker.

A second example which describes another way of describing a New York Times newspaper in the Content Classification Library 230 and a specific issue of this newspaper in the Disaggregated Content Storage 270, is illustrated below. Again assuming that the New York Times is a daily newspaper with two columns—a “News” column consisting of “International” and “Business” sections and a “Features” column consisting of “Arts” and “Books”—and that a business news article named “Alltel to Spin Off Land-Line Phone Unit” was published in the New York Times newspaper on Dec. 9, 2005; the Content Types 231 required to classify The New York Times Content source can be as presented in table 2.1 below:

TABLE 2.1
Content Types 231 for The New York Times Content source

| | Content | Update/Issue | References to Parent |
|---|---|---|---|
| Content Type ID and | Fields | Frequency | and/or Child Content |
| Name | Enum. | Info | Types |
| 232 | 233 | 234 | 235 |
| 1. “Entire | Issue # | Daily | Child: 2, 3 |
| Newspaper” | | | |
| 2. “The News | n/a | Daily | Parent: 1 |
| Column” | | | Child: 4, 5 |
| 3. “The Features | n/a | Weekly | Parent: 1 |
| Column” | | | Child: 6, 7 |
| 4. “The International | n/a | Daily | Parent: 2 |
| Section” | | | Child: 8 |
| 5. “The Business | n/a | Daily | Parent: 2 |
| Section” | | | Child: 8 |
| 6. “The Arts Section” | n/a | Weekly | Parent: 3 |
| | | | Child: 8 |
| 7. “The Books | n/a | Weekly | Parent: 3 |
| Section” | | | Child: 8 |
| 8. “A Business | Title, | n/a | Parent: 5 |
| Section Article” | Authors, | | |
| | Body Text | | |

References to Parent and/or Child Content Types 235 establish the hierarchy of Content Types within the New York Times content source in the same way as they do in the first example. However, in this second example the content types differentiate among specific columns and specific sections such that, for example, the “New Column” content type is not the same as the “Features Column”, while in the first example there is one common content type called “Column” that represents both News and Feature columns.

The content units of the Dec. 9, 2005 issue of The New York Times Content Source can be as presented as shown in table 2.2 below:

TABLE 2.2
Content Units 280 for the Dec. 9, 2005 issue of The New York Times
Content Source

| | | | | Ref. to | |
|---|---|---|---|---|---|
| | | | Content | other | Keyword |
| Content | Content Type | | Date | Content | Search |
| Unit ID | Info | Content Text Fields | Info | Units | Index |
| 288 | 281 | 285 | 283 | 287 | 286 |
| 1 | 1. “Entire | Issue# = 1234 | Dec. 9, 2005 | | |
| | Newspaper” | | | | |
| 2 | 8. “A Business | Title = “Alltel to Spin Off | Dec. 9, 2005 | Parent = 1 | alltel |
| | Section | Land-Line Phone Unit” | | | sorkin |
| | Article” | Authors = ANDREW | | | belson |
| | | ROSS SORKIN, KEN | | | AT |
| | | BELSON | | | |
| | | Body Text = “Alltel, the | | | |
| | | nation's largest rural | | | |
| | | telephone company, said | | | |
| | | today it would spin off its | | | |
| | | land-line unit and merge it | | | |
| | | with Valor . . . ” | | | |

In this example, the Keyword Search Index 286 is filled in for only the smallest indivisible Content Unit with the ID 8; however, in other embodiments of the system the Keyword Search Index 286 is filled in for Content Units on any level of Content hierarchy, for example the higher levels could aggregate the Keyword Search Indices of all their child Content Units.

FIG. 3 illustrates subsystems of User Authentication 300 component, as per one embodiment of the present invention. User Authentication 300 is required each time a customer logs into the system to search for content, define his/her preferences or download the predefined content. User Authentication 300 in one embodiment of the invention is used in conjunction with the Content Delivery System 600 to ensure that the content is delivered to the user once the user is authenticated. In general, User Authentication 300 may be involved whenever the user interacts with the Client Site 120. User Authentication 300 is a component within the Central Processing Site 120 that may reside in the same process with the other Central Processing Site 120 components or in a separate process on a different workstation coupled with the other workstations through Network 142. Authentication is initiated by the customer who makes a request into the Central Processing Site 120, or by the Content Delivery System 600 before delivering content to the user.

Methods of authentication include, but are not limited to, using Login/Password Authentication 312, Public/Private Key Authentication 314, and Biometric Authentication 316. Login/Password Authentication 312 requires the user to identify himself/herself by requesting login name, password, secret question and answer, and/or possibly a set of other fields. These input fields are matched to the fields stored in the Authentication Info 438 of the User Information Storage 430 to determine if the user is authenticated or not. Public/Private Key Authentication is based on asymmetric cryptography in which each user first generates a pair of encryption keys, the “public” and the “private” key. Messages encrypted with the private key can only be decrypted by the public key, and vice-versa. Numerous different techniques exist and may be devised using asymmetric encryption, but they are all based on the premise that the private key is known only to its rightful owner and the requirement that a piece of content should be generated and encrypted with one key on one side and sent to the other side, decrypted there with the other key and verified against the original content. For example, Authenticate User 320 may generate a random unique piece of content and encrypt it by the user's public key stored in Authentication Info 438, then transmit it to the user's Client Browser 710, which decrypts it with the user's private key and sends the proof of the decryption back to the Authenticate User 320. The proof could be the decrypted content in plain format and if the proof has been sent back then the user is authenticated. Alternatively, the Client Browser 710 may send a digital certificate encrypted by the user's private key to Authenticate User 320. If the latter is able to decrypt it successfully with the user's public key stored in Authentication Info 438 and possibly verify the digital certificate with a third-party authority that could have issued it, then the user is authenticated. Biometric authentication is based on unique biometric codes of each human individual, such as, but not limited to, fingerprints, face recognition software, weight verification, body mass index measurement or retinal scan. For this method to work the Client Browser 710 should be coupled with the Biometric Scanning Device 317 component via Client-Side User Authentication 390. Biometric Scanning Device 317 component may include all biometric devices which function as a verification for an individual identity using biometric codes. When a user makes a request into the Central Processing Site 120, Authenticate User 320 requests the digitized biometric code of the user, who uses the Biometric Scanning Device 317 to generate it, and Client Browser 710 and Client-Side User Authentication 390 to transmit it. Upon receiving the digitized biometric code, Authenticate User 320 verifies it against the sample stored in Authentication Info 438 and authenticates the user if it matches. Alternatively, any combination of the above listed authentication methods may be used together to enforce security.

Client-Side User Authentication 390 is a component residing in the Client Site 700 that facilitates the authentication by gathering and sending the necessary data to Authenticate User 320. However, this component may as well include some or all of the partly or completely be part of the client site 700. For example, in one embodiment biometric authentication is performed by Client-Side User Authentication 390 in the Client Site 700, public/private key authentication could be performed by User Authentication 300 in the Central Processing Site 120, and login/password authentication may be performed by both Client-Side User Authentication 390 and User Authentication 300. In that case, the user may be required to pass biometric authentication at the client side, public/private key authentication at the server side and pass login/password authentication either two times or pass it only one time at either the client side or the server side in case the Client Site Login/Password Authentication 312 was disabled by, for example, turning off JavaScript in the Client Browser 710. In cases when parts or all of the User Authentication 300 reside in Client-Side User Authentication 390, the latter may store all or part of the necessary Authentication Info 438 on the Client Site 700 and request the remaining authentication data from the Central Processing Site 120 via Authenticate User 320.

In one embodiment, authentication is initiated by the Content Delivery System 600, in which case the user would be required to authenticate through the Client Playback Daemon 750 that receives the delivery request from the Content Delivery System 600. The Client Playback Daemon 750 may use the authentication services provided by User Authentication 300 and/or Client-Side User Authentication 390. In the event that the content is delivered directly to Playback System 730 bypassing Client Playback Daemon 750 (shown by arrow 811), User Authentication 300 can still employ some of its authentication services. For example, the content may be delivered to the user's cellular phone and the user may be required to pass login/password Authentication 312 by: a) entering his/her login name, password, and/or secret question on his/her cellular phone's keyboard or b) by pressing a number on his/her phone's keyboard and thus identifying his/her correct login name, password and/or secret question in a numbered list of samples pronounced by a human voice through the phone.

FIG. 4 illustrates subsystems of User Preference Management 400, as per one embodiment of the present invention. User Preference Management 400 is coupled with the Client Browser 710 via Network 142 and through the User Authentication 300 in order to make sure the preferences are accessed and modified by authenticated users. User Preference Management 400 component retrieves information about the user, authentication information and preferences regarding the content and audio format. A user may be automatically redirected to User Preference Management 400 as soon as the user is registered with the system in order to fill in the necessary data, or the user may choose to fill in the data at his/her own discretion any time when he/she logs into the system. Input Preferences 440 stores Statistical Information 434 (such as Name, Address, Phone, etc.), Billing Information 436 and Authentication Info 438 (Login/Password or upload Public Key or upload digitized Biometric Codes) in User Information Storage 430. Additionally, the Input Preferences 440 receives preferences from the user and then stores these user preferences in User Preferences Storage 410.

User preferences fall into several categories—content preferences, delivery frequency preferences, delivery methods preferences, audio file format preferences, audio preferences, playback order preferences and language preferences. To identify content preferences, Input Preferences 440 retrieves information about available content sources 238 from the Content Classification Library 230 and lets a user choose the content sources he/she is interested in. Moreover, Input Preferences 440 may let the user choose not only among content sources but also among certain content elements within specific content sources, as classified in the Content Classification Library 230. For example, the user may specify in what sections he/she is interested for a certain newspaper Content Source. In addition, the user may also specify in which keywords he/she is interested, wherein the keywords may be global for a content source or relate to specific content types within the content source; and keywords may be specified for each content field of each content type. For example, the user may specify keywords “John Doe” for the “Author” Field of an “Article” content type for a newspaper, meaning that he/she is interested in articles written by John Doe. If he/she additionally specifies that he/she is interested in the “Arts” section of the content source he/she will receive only articles about Art written by John Doe. The user may enter one or more sets of such keywords for each content type in a content source and the system would search for the content based on those content preferences independently and would then combine the search results and deliver the content to the user. The user may enter the keywords through the Client Browser 710 using a user interface, including using special language for constructing keyword queries. User content preferences are stored in Content Preferences 413.

Content elements selected by the user have different frequencies of updates—some content is produced on a daily basis, while others may be produced on a weekly or monthly basis. User may want to hear the content as soon as new content is available, or accumulate the content and deliver it to the user according to a certain schedule. For example, the user may want to listen to the news every morning, and listen to everything else once a week. Delivery Frequency Preferences 414 store information about how often to deliver content elements selected by the user and stored in Content Preferences 413.

User may prefer different delivery methods for different pieces of content. For example, he/she may prefer to listen to news via a satellite radio, and listen to everything else through the playback software on his/her PC. In case the user listens to the audio through the software on his/her PC, he/she may want to start listening to the audio immediately as it starts coming in, i.e., in a streaming mode, or he/she may want to start listening to it only after the audio has been completely delivered and stored in his/her Playback System 730 (i.e., downloaded). In the latter case, the user may want to wait until all audio files have been delivered or the user may want to start listening to the audio as soon as the first file has been delivered. The user may also desire the content to the emailed to him/her. Other delivery methods (i.e. modes) for delivery of content to the user may also be specified, such as, a scheduled transfer mode, batch transfer mode or user-initiated transfer mode of content. Delivery Method Preferences 415 store information about how the user wants specific content elements selected by the user and stored in Content Preferences 413 to be delivered to him/her. Additionally it may store information about the destination where to deliver the content, for example phone number.

Audio Format Preferences 416 stores information about the file format of the audio content that the user receives. Examples of common audio file formats include, but are not limited to, MP3, MP4, WMA (Windows Media® Audio), QT (Quicktime®), RA (RealAudio®), RAM (Real Audio Movie), or Wav. It should be noted that there are or may be many other formats of files that contain digitized audio information. Users may define their preferred format for audio file and can change this for different content elements, if desired. Audio Format Preferences 416 stores user's audio file format preferences regarding each content element selected by the user and stored in Content Preferences 413.

The audio preferences encompass options which include, but are not limited to the choice of voice, pitch, tone, speed, volume, language, and other audio selections. Audio preferences may be defined by the user for each content element individually, for groups of elements or sources of information or there may be a single global definition of audio preference. Audio Preferences 417 store information about the user's audio preferences for each content element selected by the user and stored in Content Preferences 413. The user is able to name specific sets of audio preference options and when selecting audio preferences for new content elements he/she is able to quickly select previously named audio preferences, thus grouping content elements based on audio preferences quickly.

Since Delivery Frequency Preferences 414 may be such that the user would receive many different audio files at once, the user defines the order in which the audio files would either be sorted in Client Playback Daemon 750 and/or played through the Playback System 730. If the delivery method is such that the audio would not be stored first on data storage, as is the case with phone or satellite radio, then the ordering would mean the order in which the audio is transmitted to the Playback System 730 in Client Site 700. To define the order, the user may simply enter rankings for each content element selected by the user and stored in Content Preferences 413, or the user may move Content Elements up or down in a list of Content Elements. The order may be specified using other means as well.

Playback Order Preferences 418 stored in the User Preferences Storage 410 specifies the order in which the audio files are delivered to the user and played. These preferences are based on the Content Preferences 413. Playback Order Preferences 418 store the playback order for each content element identified in his/her Content Preferences 413. To identify the playback order, the user may enter a numerical rank for each content element so that when the system makes the delivery to the user it starts the delivery with the highest ranking piece of content. Alternatively, since there is a certain content hierarchy for each content source, (for example articles belonging to a certain section, or news belonging to a certain topic) and the hierarchy is specified in the Content Classification Library 230 described in FIG. 2, the user may specify ranking for certain Content Type 231 as well, in which case the ranking may be automatically propagated to all pieces of content of that type or other types that descend from that type as set by the References to Parent and/or Child Content Types 235 in the Content Classification Library 230. Alternatively, instead of entering numeric values to specify the ranking, the user may move the content elements identified in Content Preferences 413 and/or Content Types 231 up or down in an ordered list, thus changing their order or the user may use voice commands when communicating with a Customer Service Call Center to specify the ranking of the content elements identified in Content Preferences 413 and/or Content Types 231.

The user may change the playback order of specific audio files that were or are to be delivered to him/her. In case the user logs into the system and uses Select Content for Download 332 (to be described later) to identify audio files to be delivered, he/she may as well identify the order in which those files should be delivered. In case the files are delivered to the Client Playback Daemon 750, the user may use the daemon to change the audio file ordering by either typing numerical rank values, or moving the files up or down in a list, or giving voice commands to the daemon in case the daemon is equipped with a voice recognition software. The daemon would then use the new audio file order when redirecting the audio files to the PC/PDA Audio Devices & Software 732 (to be described later). In case the audio files are delivered to the Regular/Cellular Phone 714 (to be described later) or to the Client Playback Daemon 750 equipped with the voice recognition software, the user may use voice commands to specify the file order, or even postpone playing and/or delivery of audio files; for example, such voice commands may include but are not limited to “play later”, “skip”, “delete”.

The user may also be able to combine different sources and topics to indicate audio files that they are interested in. These topics and sections can be grouped as playlists for the users.

FIG. 5 illustrates a preferred embodiment of the present invention for delivering customizable audio content to customers/users. In this embodiment, content delivery is initiated by a user through Client Browser 710. After being authenticated by User Authentication 300, the user selects the content for download from the Select Content for Download component 332. This component may offer the user an option to download the content based on user preferences found in User Preferences Storage 410 (specifically Delivery Method Preferences 415) and entered by user at an earlier time. Alternatively, the Select Content for Download component 332 may offer the user the option of modifying the user preferences permanently, may offer the user the option of entering one-time user preferences for this particular download session, or combine content based on user preferences stored in User Preferences Storage 410 and one-time user preferences specified for this particular download session. When entering one-time preferences, the user may specify user preferences based on available content sources and content types contained in the Content Classification Library 230 in the same way as he/she specifies permanent user preferences regarding content, or the user may search the actual content contained in Disaggregated Content Storage 270 and request that the content found in the search be delivered to him/her. Once Select Content for Download component 332 identifies the content for download, it passes the information to the Audio Content Delivery 610 component that reads the data from the Disaggregated Content Storage 270 and searches within it for the content requested by the user. Disaggregated Content Storage 270 is the repository for the textual content that was retrieved from Content Providers 110 and disaggregated into Content Units 280, as described in FIG. 2. In case Audio Content Delivery 610 does not find all or some pieces of the content in the Disaggregated Content Storage 270, Audio Content Delivery 610 may either a) proceed with the available content, or b) initiate Scan Content Providers 210 to scan the Content Providers for the content requested by the user and then transmit the retrieved data to the Disaggregate Content 250, which then disaggregates the content into Content Units and stores them to Disaggregated Content Storage 270. Once the content units requested by the user are in Disaggregated Content Storage 270, Convert Data 550 converts the content units to audio based on the Audio Preferences 417 and Audio Format preferences 416 that it gets from user Preferences Storage 410 in order to determine audio options such as voice, pitch, tone, etc. Convert Data 550 puts the converted audio data to Audio Content Storage 570. Convert Data 550 may not convert the data to audio if this data has already been converted earlier for this user or another user whose Audio Format Preferences 416 and Audio Preferences 417 exactly match those of the current user. In any case, the audio data converted and stored in Audio Content Storage 570 is marked up for delivery to the user. Deliver Content 630 delivers the audio content from Audio Content Storage 570 to Client Playback Daemon 750 or directly to Playback System 730 via Distribution Network 140 as soon as the audio data has been delivered to Client Site 700. The audio data that was delivered to the user may be erased from Audio Content Storage 570. In one embodiment of the invention, the audio is not erased immediately and lives there for a limited or indefinite time to be used for the delivery of audio content for other users. In another embodiment, specific content units in Disaggregated Content Storage 270 are erased as soon as they have been converted to audio.

In yet another embodiment, this process is initiated not by the user himself/herself but by a Client Playback Daemon 750 residing on the client side and knowing the user preferences by either reading from User Preferences Storage 410 from the Central Processing Site 120 or storing User Preferences locally on the Client Site 700.

Scanning of content providers to retrieve content may be performed according to a regular schedule for each Content Source as is specified in the Content Classification Library 230. Alternatively, Content Providers 110 may make calls into Scan Content Providers 210 and either notify the latter that the former have new content which needs to be scanned or transmit the new content right away. Please note that advertisements can also be included and provided to users in addition to the audio files desired by the user.

FIG. 6 illustrates another embodiment of the present invention, for delivering customizable audio content to customers/users, in which the content delivery is initiated by the Content Delivery System 600 and not the user or the Client Playback Daemon 750. In this embodiment, Audio Content Delivery 610 reads the user preferences for Content Preferences 413, Delivery Frequency Preferences 414 and selects the appropriate content and delivery timing. Specifically, by regularly reading user preferences regarding content and delivery from User Preferences Storage 410, Audio Content Delivery 610 detects which content should be delivered, when it should be delivered and to which users it should be delivered. Audio Content Delivery 610 then reads the data from the Disaggregated Content Storage 270 at appropriate times to detect whether it contains the content that should be delivered to the users. In case all or some pieces of the content are not found, Audio Content Delivery 610 may either a) proceed with the available content or b) make Scan Content Providers 210 scan the Content Providers for the content requested by the user and transmit the retrieved data to the Disaggregate Content 250 that disaggregates the content into Content Units and stores them in Disaggregated Content Storage 270. Once the content units requested by the user are in Disaggregated Content Storage 270, Convert Data 550 converts the content units to audio, using the Audio Preferences 417 and Audio Format Preferences 416 that it gets from user Preferences Storage 410 in order to determine audio options such as voice, pitch, tone, etc. Convert Data 550 stores the converted audio data to Audio Content Storage 570. Convert Data 550 may not convert the data to audio if this data has already been converted earlier for this user or another user whose Audio Format Preferences 416 and Audio Preferences 417 exactly match those of the current user. In any case, the audio data converted and stored in Audio Content Storage 570 is marked up for delivery to the user. Deliver Content 630 delivers the audio content from Audio Content Storage 570 to Client Playback Daemon 750 or directly to Playback System 730 via Distribution Network 140 as soon as the audio data has been delivered to Client Site 700. In one embodiment of the invention, the audio is not erased immediately and lives there for a limited or indefinite time, wherein the audio is used in the delivery of audio content to other users (who have requested the same audio content). Alternatively, specific content units in Disaggregated Content Storage 270 are erased as soon as they have been converted to audio.

Scanning of content providers to retrieve content may be performed according to a regular schedule for each Content Source as is specified in the Content Classification Library 230. This Library contains information about Content Sources 238 available from Content Providers 239. Having this information in place, Scan Content Providers 210 is aware of what Content Providers exist and what Content Sources they provide. Furthermore, the Content Classification Library 230 describes each Content Source, including Update/Issue Frequency Info 234 so that Scan Content Providers 210 knows how often it should scan for content updates. Alternatively, Content Providers 110 may make calls into Scan Content Providers 210 and either notify the latter that the former has new content which needs to be scanned or transmit the new content right away.

FIG. 7 illustrates yet another embodiment of the present invention for delivering customizable audio content to customers/users. This embodiment differs from those illustrated on FIG. 5 and FIG. 6 in that disaggregated content is not stored in Disaggregated Content Storage 270. Instead, as soon as the content is disaggregated by Disaggregate Content 250, it gets converted to audio and stored in Audio Content Storage 570. Audio Content Storage 570 thus has to store the audio content in all possible variations of Audio Format Preferences 416 and Audio Preferences 417 that are described in FIG. 4. Consequently, in this embodiment, the content is stored completely in audio formats where a single piece of content would likely be stored in numerous audio formats to allow for the spectrum of audio preferences. Each audio file stored in Audio Content Storage 570 thus has the Audio Settings 575 information attached that specifies audio options such as but not limited to voice, pitch, tone, speed, volume and language, and the Audio Format Preferences 573 that specifies the audio file format. Additionally, since the content units are not stored in the Disaggregated Content Storage 270, Audio Content Storage 570 has to store Content Type Info 281, Content Date Info 283, Content Miscellaneous Information 284 and Keyword Search Index 286 that would normally be stored in Disaggregated Content Storage 270. The content hierarchy is reconstructed through the References to other related/contained Audio Units 580 field stored in Audio Content Storage 570. This field is an equivalent of the References to other Content Units 287 field that would be stored in Disaggregated Content Storage 270.

In this embodiment, Audio Content Delivery 610 searches for the content in the Audio Content Storage 570 instead of Disaggregate Content 250, however it uses the same fields that it would have used if it had to search for the content within Disaggregate Content 250. Those fields are Content Type Info 281, Content Date Info 283 and Keyword Search Index 286. Also, in this embodiment, Deliver Content 630 obtains information from User Preferences Storage 410 to know which format to use when sending audio to the users. It matches Audio Preferences 417 and Audio Format Preferences 416 from the User Preferences Storage 410 with Audio Settings 575 and Audio Format 573 in Audio Content Storage 570, and thus finds the audio content that matches user audio preferences.

During the selection of content for download, as illustrated in FIG. 5, a user may perform keyword searches to find actual content. The disaggregated content units are tagged with keywords to facilitate these keyword searches. Keyword search is a technique in which the user enters the terms i.e., keywords, and an electronic system searches for the data based on those keywords. In one embodiment of this invention, the system searchs within all Content Text Fields 285 of all Content Units 280 stored in the Disaggregated Content Storage 270 illustrated in FIG. 2. In another embodiment, the system lets the user choose filter options such as, a) allows the user to specify certain Content Sources 238, and/or certain Content Types 231 and b) specify certain search criteria for certain Content Text Fields 285 of certain Content Types 231 stored in the Disaggregated Content Storage 270. For example, the system would allow the user to search for the Belson keyword in the Author field of a business article in the New York Times Newspaper content source. During the search the system compares the keywords against the text of the Content Text Fields 285. The system may choose to exactly match several or all keywords to words in the content, and/or it may perform morphological analysis on the keywords for detecting the keyword inflexion and clipped words. It may also request the user whether it should match the keywords exactly, or it may provide advanced search options to the user in which the latter would construct the query consisting of keywords and a special syntax that would command the system how the keywords should be searched for. For example, the following search query would search for the business news about the Alltel® Corporation or articles about Claude Monet's works: “(business AND news AND Alltel) OR (Claude AND Monet AND article)”. The system may rank and present the found content units to the user in order of their relevance using different techniques from simple counting the number of keyword matches to mathematic fuzzy logic techniques for which different factors are accounted, for example, the importance of a piece of content in which the keyword matches were detected (the keyword match in the title of an article would be more important than a keyword match in the body text).

In another embodiment, the system not only searches within its own Disaggregated Content Storage 270 but also request Content Providers 110 through Scan Content Providers 210 to do the keyword search, and in case Content Providers 110 find matching content, the system chooses to fetch, disaggregate and convert the disaggregated content as described in FIGS. 5, 6 and 7. The keyword tags for disaggregated content units are maintained even after the conversion of these content units. Once the system finds content units that match the search criteria and the user confirms during Select Content for Download 332 that he/she wants the content to be delivered, then Audio Content Delivery 610 ensures that the content is or has already been properly converted and is properly delivered to the user.

To facilitate keyword searches, Disaggregated Content Storage 270 may store Keyword Search Index 286 for each Content Unit 280. This index may include data for each or some of the Content Text Fields 285 of the content unit, and/or it may aggregate data for other content units that are logically contained within the given content unit.

In another embodiment, the user performs keyword searches not only to find specific content, but to specify his/her content preferences as well. The user would enter keywords for the topics in which he/she is interested, and the system would find the content sources and content types that match the keywords. In this case, the data in Content Classification Library 230 should be organized in a way resembling table 1.1 because the search would be done within the Content Classification Library 230 and the system must contain full information about the hierarchy of content sources without having actual content data in Disaggregated Content Storage 270.

FIG. 8 illustrates subsystems of Client Site 700, that specify ways to interact with Central Processing Site 120, as per the present invention. Whenever a user interacts with the system he/she uses the Client Browser 710 to log into the Central Processing Site 120 and carry out the tasks. Client Browser 710 is an application implemented using software or hardware, which is used by a user to interact with the central processing site. This includes situations in which the user defines preferences during Input Preferences 440 or specifies content search criteria when searching for specific content during Input Search Criteria 332.

In one embodiment, Client Browser 710 consists of Software Browser 712 which is a web-browser based application, a web-enabled desktop application or instead uses a proprietary non-web technology for remote communications. Data is transmitted to by Software Browser 712 to Central Processing Site 120 via Client Side User Authentication 390 and via Network 142. The Software Browser 712 may provide the user with a Web User Interface in which the user performs his/her tasks by entering information into forms on the web-pages. Software Browser 712 may provide the user with a traditional Desktop Application User Interface where the user fills out forms and fields by means provided by an Operating System (OS). For example, on a Windows® OS the user uses the Graphical User Interface (GUI) to enter information. The Software Browser 712 may also provide the user with a command-line user interface in which the user types in commands that are translated and acted upon by the browser. Further, Software Browser 712 may employ voice recognition to facilitate data entry. The Software Browser 712 may also provide the user with a combination of these interfaces and techniques.

Client Side User Authentication 390 is a software component in Client Site 700L that facilitates user authentication and is used whenever Client Browser 710 interacts with the Central Processing Site 120. This component may just gather the data necessary for authentication and transmit it to User Authentication 300 or it may perform user authentication itself. Biometric Scanning Device 317 is a set of devices on the Client Site 700 that scan biometric codes of the user and are used by the Client Side User Authentication 390. This set may include such devices as fingerprint scanners, face recognition devices, weight verification devices, body mass index measurement devices or retinal scanners. Both Software Browser 712 and Client Side User Authentication 390 are software components installed at the user's Personal Computer (PC) or Personal Digital Assistant (PDA), which is represented by the User PC/PDA 702 block on the FIG. 8.

In another embodiment, Client Browser 710 consists of a regular phone or a cellular phone represented by the Regular/Cellular Phone 714 component. When interacting with the Central Processing Site 120, the user uses a regular or a cellular phone to log-into the system and carry out the tasks. The user may interact with the Central Processing Site 120 by calling the Customer Support Operator 912 at the Customer Service Call Center 910 at the Central Processing Site 120 through Telephony Services Provider 900. The Customer Service Call Center 910 may as well support Computerized Customer Support 914 in which the latter may use voice recognition in order to input the preferences dictated by the user in the language preferred by him/her through the phone. Computerized Customer Support 914 may pronounce numbered lists of possible options in human voice and the user may react to by typing corresponding option numbers on his/her phone's keyboard. The user may still have to pass User Authentication 300; however, this user authentication would be limited to the authentication methods supported by regular and cellular phones.

The Client Browser 710, in another embodiment combines both the Software Browser 712 and Regular/Cellular Phone 714.

FIG. 9 illustrates subsystems of Client Site 700, as per one embodiment of the present invention, which specify ways through which the content may be delivered and played on the Client Site 700. In all possible combinations, the delivered audio content is played through the Playback System 730. Playback System 730 consists of the devices that allow for the user to listen to the audio content.

In one embodiment, Playback System 730 consists of PC/PDA Audio Devices and Software 732 that represent hardware audio devices such as audio card and speakers, and the necessary software such as system audio drivers/codecs that are plugged into or installed at the user's Personal Computer (PC) or Personal Digital Assistant (PDA) represented by block User PC/PDA 702 in FIG. 6. PC/PDA Audio Devices & Software 732 cannot receive the content directly from the Content Delivery System 600 at the Central Processing Site 120. Mediators such as Client Playback Daemon 750 and Software Browser 712 receive the audio content and redirect it to the PC/PDA Audio Devices & Software 732. Client Playback Daemon 750 is a software component residing on User PC/PDA 702.

Client Playback Daemon 750 reads user preferences from the User Preferences Management 400 component or stores user preferences locally in User Preferences Storage 420 and reads them from the local copy, in one embodiment. Depending on user preferences, Client Playback Daemon 750 requests the Content Delivery System 600 for content and the latter delivers the content to Client Playback Daemon 750 through Network 142. In another embodiment, the Content Delivery System 600 reads user preferences from User Preferences Management 400 and makes requests into the Client Playback Daemon 750 notifying it about the availability of the new data and transmitting the audio data to the Client Playback Daemon 750. In both cases, Client Playback Daemon 750 first needs to pass authentication through the Client-Side User Authentication 390 that gathers the necessary data and sends it to the User Authentication 300 or performs the authentication on its own. Since the user does not participate in both cases, Client Side User Authentication 390 has to store authentication parameters locally, such as biometric codes or Login/Password, to be able to pass them to User Authentication 300. In yet another embodiment, the user commands the Client Playback Daemon 750 to check the Central Processing Site 120 for new content. In that case the Client Side User Authentication 390 does not store authentication parameters, however, requests them from the user. In all the three embodiments, after Client Playback Daemon 750 passes authentication the downloading of the audio data from the Content Delivery System 600 through Network 142 occurs. Depending on user preferences, Client Playback Daemon 750 may start playing the received data through PC/PDA Audio Devices & Software 732 as soon as it receives the first piece of the first audio file, or the audio content may be entirely downloaded and played in a specific order, or the Client Playback Daemon 750 may notify the user somehow, for example, by producing a brief sound effect, or sending email to the user that the content has been downloaded and wait for the playback confirmation from the user. In case when Client Playback Daemon 750 starts redirecting audio content as soon as it receives the first piece of data, it may elect to do so only after receiving the piece of data large enough to ensure buffering of the audio data so that the playback is smooth. The technique in which the playback starts before the file's content has been completely downloaded and occurs in parallel with fetching the remaining content from an external source is called “streaming”. In yet another embodiment, the audio content is delivered directly to Software Browser 712 and not to the Client Playback Daemon 750. In this scenario, the user logs into the system through Software Browser 712 employing Client-Side User Authentication 390 and User Authentication 300. After the user is authenticated, Content Delivery System 600 outputs the audio content through Network 142 to the Software Browser 712. For example, Software Browser 712 may include an audio playback software component such as: Microsoft Windows Media Player Control, a custom-developed ActiveX Audio Playback Control, or an embedded Audio Playback Object such as one implemented on Macromedia Flash MX, on a web-page that would receive and play audio from the Content Delivery System 600. The audio may be delivered in a streaming mode through Network 142, or, depending on the user's preferences, the playback software component may be commanded by the Software Browser 712 to completely download the audio files in a batch mode through Network 142 by using HTTP, TCP/IP or other protocols before it starts redirecting the audio data to PC/PDA Playback Devices & Software 732. In another embodiment, the Content Delivery System 600 also transmits the textual content along with the audio, in which case the Client Playback Daemon 750 displays the text to the user and highlights the portions of the text being read.

In another embodiment, Playback System 730 consists of Regular/Cellular Phone 714 or Satellite Radio Device 737 or any other device capable of receiving and playing the audio data through Distribution Network 140. Since Satellite Radio 901 is a one-way communication network, Content Delivery System 600 is not able to authenticate the user and has to rely on the assumption that the destination device is indeed controlled by the user who specified this Satellite Radio Device's address earlier in his/her delivery method preferences. In case when content is to be delivered via a two-way communication network, such as Telephony Services Provider 900, to Regular/Cellular Phone 714, the user may be authenticated through, for example, login/password authentication by: a) entering his/her login name, password, and/or secret question on his/her cellular phone's keyboard, or b) by pressing a number on his/her phone's keyboard and thus identifying his/her correct login name, password and/or secret question in a numbered list of samples pronounced by a human-like voice through the phone.

The Playback System 730 may also combine PC/PDA Audio Devices and Software 732 and Regular/Cellular Phone 714 and/or Satellite Radio Device 737. For example, when the user defines his/her preferences, the user may specify that the news be delivered to his/her Satellite Radio Device 737, and everything else to the Client Playback Daemon 750 on his/her PC/PDA 702.

It is worth noting that Playback System 730 implementation is independent from the methods of initiating content delivery and the methods in which the user interacts with the system. In other words, the Playback System 730 constituents may receive the content regardless of the way the delivery was initiated as described in FIGS. 5, 6, 7 and 8. For example, in his/her Delivery Method Preferences 415 the user might have specified that he/she wishes The New York Times business news to be delivered to his/her phone, the New York Times articles in the art section to be streamed to his/her PC, and a web-site's RSS articles to be delivered to a satellite radio device that can be equipped in his/her car. In this case the Delivery Methods Preferences 415 would contain the delivery information for each selected type of content, i.e. it would contain the phone number to know where to deliver business articles, the PC's IP address and the “streaming” marker to know at what PC and in what mode to deliver the articles about art, and the satellite radio device's channel information to know where to deliver the RSS articles. The actual delivery to those destinations could be done by the Content Delivery System 600 that checks the Disaggregated Content Storage 270 and/or Content Providers 110 regularly or according to a certain schedule or by receiving notifications from Content Providers 110 to find out whether there is new content to deliver to the user and checks the user's Delivery Frequency Preferences 414 to know how often the user wants the content to be delivered. Alternatively, the delivery to the phone, PC and satellite radio destinations could have been initiated by the user himself/herself by logging into the system and requesting the delivery through Select Content for Download 332, in which case the delivery would be carried out to destinations specified by the user in his/her Delivery Method Preferences 415, or the user may specify one-time delivery preferences. For example, the user may request business news as well as art articles to be delivered to his/her PC during this particular download session.

FIG. 10 illustrates subsystems of Content Conversion System 500, as per one embodiment of the present invention. Content Conversion System 500 converts textual content retrieved from Content Providers into audio files and store them in the Audio Content Storage 570.

Content Conversion System 500 consists of the Text-to-Speech Translation 530, Foreign Language Translation 510, Audio Content Storage 570 and Convert Data 550 components. Convert Data 550 receives textual content units, converts them into audio files and stores them in an audio storage. FIG. 10 illustrates an embodiment in which Convert Data 550 receives the data from Disaggregated Content Storage 270. Disaggregated Content Storage 270 stores the textual content received from content providers and then disaggregated into Content Units.

Convert Data 550 converts Content Text Fields 285 of each Content Unit 280 into audio files and stores them in the Audio Content Storage 570. The audio files are accompanied with the following information:
a) Client Information including Client ID 571 which identifies the user to whom the audio content should be delivered; please note that this field will not be stored in the embodiment illustrated in FIG. 7 in which the Audio Content Storage 570 stores the audio in all possible combinations of languages, audio preferences and audio file formats
b) Reference(s) to Content Unit(s) 572 which identifies the Content Units 280 that are the source of these audio files; in one embodiment of the invention several Content Units 280 are converted into a single audio file, in which case Reference(s) to Content Unit(s) 572 would refer to several content units and have information about what portions of the audio file correspond to what content units. The example of several content units being converted into single audio file is a newspaper section with all its articles being converted into a single audio file for delivery to a certain user. In other embodiments of the invention, one Audio File 574 would match exactly one Content Unit 280; in that case if for example the system were required to deliver all articles of a certain section to the user it would look up the Content Unit IDs 288 in the Disaggregated Content Storage 270 and then find all matching audio files in Audio Content Storage 570.
c) Content Audio Files(s) 574 are the actual audio files which will be listened to by the user; the audio files are generated according to the user's Audio Preferences 417 and Audio Format Preferences 416 stored in the User Preferences Storage 410. These audio files may be stored in a binary form as the values of the fields in the database or they may be stored on the hard disk or any other form of digital information storage as audio files and referenced from the database. In certain embodiments, one Audio File 574 matches one Content Unit 280; in other embodiments, one Audio File 574 matches several Content Units 280; in yet another embodiment, several Audio File 574 match one Content Unit 280—in that case there would be one audio file for each Content Text Field 285 of the Content Unit 280 and Reference(s) to Content Unit(s) 572 would contain the information about which audio file corresponds to what content text field of which content unit.
d) Playback Order 576 defines the playback order in case there are two or more files in Content Audio File(s) 574 or there is one large compound audio file in Content Audio File(s) 574 that matches several Content Units 280. The ordering of the audio file content was determined by the Playback Order Preferences 418 component of the User Preferences Management 400
e) Delivery Date/Time 578 stores the information about the time when the audio content should be delivered to the user
f) Time-To-Live 579 controls how long the given Content Audio File(s) 574 are stored in the database

In order to convert content units into audio files automatically, Convert Data 550 uses the Text-to-Speech Translation 530 component. This component may be based on any existing Text-To-Speech (TTS) engines, such as but not limited to VoiceText® from NeoSpeech, Acapela Group's High Quality TTS, RealSpeak® from Nuance, Lemout & Hauspie TTS3000 engine, ECTACO TTS engine, Lucent Technologies Articulator® TTS engine, or future TTS engines. Regardless of the TTS used, the Convert Data 550 feeds Content Text Fields 285 of content units that it gets from Disaggregated Content Storage 270 and Audio Preferences 417 that it gets from User Preferences Storage 410 into Text-to-Speech Translation 530 and receives the audio files back, which it then stores in the Audio Content Storage 570. By feeding in Audio Preferences 417, Convert Data 550 controls audio options such as but not limited to voice, pitch, tone and speed.

Audio Preferences 417 additionally stores the language of preference for the user. Depending on the user's language of preference, the Convert Data 550 may choose to translate the textual content into another language before converting it to audio. Foreign Language Translation 510 is the component that does the translation of the text in one language to another language automatically without human involvement. This component may be based on any currently existing language translation software in the market such as but not limited to SYSTRAN® translation products, LingvoSoft® translation products, Aim Hi electronic translators, LEC Translate products, or any future language translation software. Convert Data 550 feeds Content Text Fields 285 into the Foreign Language Translation 510 component and receives the translated text back, which it then feeds into the Text-to-Speech Translation 530 as described above.

Convert Data 550 may not always translate content units into audio files. If it detects that a specific content unit has already been translated into the required language and converted into the audio with exactly the same audio preferences as required it may choose not to do the translation/conversion again but to create new records in the Audio Content Storage 570 that would reference the already existing audio files. This is possible since the Content Audio File(s) 574 field may store references to actual audio files on data storage.

In the embodiment illustrated on FIG. 7, Convert Data 550 receives the textual data directly from Disaggregate Content 250. Since Disaggregated Content Storage 270 is not used, the Audio Content Storage 570 contains significantly more information. In this embodiment, Audio Content Storage 570 does not contain Client Information Including Client ID 571; instead, Convert Data 550 translates every received Content Unit into all supported languages and converts each translated piece of content into audio files using all possible combinations of audio preferences to allow for the spectrum of audio preferences.

Thus, the present invention as described above provides various enhancements over prior art, some of which are listed below:
a) ability to customize content by providing users with content selection preferences, audio preferences, audio format preferences, playback order preferences and delivery method preferences;
b) ability to automatically provide audio files for multiple audio preferences and audio format preferences using Text-to-Speech conversion without human intervention;
c) tagging content units using keywords to further customize the content selection process for users;
d) ability to provide audio files that can be played on any existing audio playback devices;
e) ability to capture articles published online after release of a print paper and incorporate these articles into a daily download option provided by user;
f) ability to set up automatic audio downloads or retrieve downloads through portable devices;
g) ability to search content providers for any content;
h) providing a user with the option of designing his/her own audio output as a combination of different sources and topics;
i) ability to insert advertisements within content being downloaded to the users;
j) ability to design audio output as combination of different sources and topics, and grouping them into playlists;
k) ability to automatically translate text in one language to another language (i.e. foreign language translation capability) without human intervention;
l) ability to combine different sources into one audio file for delivery to user, for example, news from newspapers, magazines and periodicals can be combined into one download; and
m) ability to provide different sections of content to be output to different user playback devices

Although, throughout the specification various specific examples of delivery modes, destinations, content sources, client browser component, and playback systems, are discussed, the present invention should not be limited to just these examples. Other equivalents can be substituted and are considered to be within the scope of the present invention.

Additionally, the present invention provides for an article of manufacture comprising computer readable program code contained within implementing one or more modules to customize delivery of audio information. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for:

(a) identifying textual content based on pre-stored content preferences or user content selections associated with a client;
(b) aiding in receiving said identified textual content;
(c) disaggregating said received textual content into one or more content units based on predefined content classification;
(d) automatically converting said disaggregated content units into one or more audio files based on audio preferences and audio format preferences; and
(e) aiding in delivering said one or more audio files to said client in (a) based on at least delivery method preferences.

A system and method has been shown in the above embodiments for the effective implementation of a customizable delivery of audio information. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware. Additionally the present invention should not be limited by sources of textual content, delivery method used for delivering audio files, audio preferences for content, audio format preferences for content, authentication techniques used for client authentication, client browsers and playback systems used at client sites.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats.

What is claimed is:

1. A method to customize delivery of audio content to one or more clients, said audio content derived from textual content obtained from one or more content providers, said method comprising the steps of:
a. identifying textual content based on pre-stored content preferences or user content selections associated with a client;
b. receiving and disaggregating identified textual content into one or more content units based on predefined content classification;
c. automatically converting said disaggregated content units into one or more audio files based on audio preferences and audio format preferences; and
d. delivering said one or more audio files to said client in (a) based on at least delivery method preferences.

2. A method to customize delivery of audio content to one or more clients, as per claim 1, wherein said disaggregated content units are tagged using keywords and said keywords are used in future delivery of audio content based on keyword searching.

3. A method to customize delivery of audio content to one or more clients, as per claim 2, wherein said user selections indicate keywords for said keyword searching.

4. A method to customize delivery of audio content to one or more clients, as per claim 1, wherein said textual content is obtained from a single content provider, said textual content disaggregated into content units based on said pre-defined content classification, said content units converted into audio files, and said audio files delivered to one or more client devices associated with said client.

5. A method to customize delivery of audio content to one or more clients, as per claim 1, wherein said textual content is obtained from said content providers, said textual content disaggregated into content units based on said pre-defined content classification, said content units automatically converted into audio files, and said audio files delivered to one or more client devices associated with said client.

6. A method to customize delivery of audio content to one or more clients, as per claim 1, wherein at least one audio file is stored in multiple audio formats associated with said audio format preferences.

7. A method to customize delivery of audio content to one or more clients, as per claim 1, wherein multiple variations of at least one audio file is stored according to audio characteristics associated with said audio preferences.

8. A method to customize delivery of audio content to one or more clients, as per claim 1, wherein said audio preferences comprise any of or a combination of the following: voice, pitch, tone, speed, volume and language.

9. A method to customize delivery of audio content to one or more clients, as per claim 1, wherein in addition to said one or more audio files, one or more advertisements are delivered to said client.

10. A method to customize delivery of audio content to one or more clients, as per claim 1, said one or more audio files are grouped as playlists for said client.

11. A method to customize delivery of audio content to one or more clients, as per claim 1, wherein a check is performed to see if said identified content is already available, prior to step (b).

12. A method to customize delivery of audio content to one or more clients, as per claim 1, wherein said identifying textual content step (a) is performed at regular intervals.

13. A method to customize delivery of audio content to one or more clients, as per claim 1, wherein sources of said textual content provided by said one or more content providers is any of the following: magazines, newspapers, RSS feeds, books or weblogs.

14. A method to customize delivery of audio content to one or more clients, as per claim 1, wherein said delivery of audio content is customized using additional preferences: delivery frequency preferences storing information regarding how often to deliver said one or more audio files and playback order preferences storing information regarding order in which said one or more files are to be delivered.

15. A method to customize delivery of audio content to one or more clients, as per claim 1, wherein said delivery method preferences store information regarding how said one or more audio files are delivered to said client and information regarding a destination address of a device associated with said client, where said one or more files are to be delivered.

16. A method to customize delivery of audio content to one or more clients, as per claim 15, wherein said information regarding how said one or more audio files are delivered comprises any of or a combination of: streaming mode, download mode, satellite radio mode, email mode, batch mode, scheduled transfer mode, and user-initiated transfer mode.

17. A method to customize delivery of audio content to one or more clients, as per claim 15, wherein said information regarding a destination address comprises any of or a combination of the following: phone number, IP address, and satellite radio channel.

18. A method to customize delivery of audio content to one or more clients, as per claim 1, wherein said disaggregated content units are translated from one language to another prior to said converting step (c).

19. A central processing site to customize delivery of audio content to one or more clients, said audio content derived from textual content obtained from one or more content providers, said central processing site comprising:
a) a user preferences management component storing at least the following preferences: content preferences, delivery method preferences, audio preferences, and audio format preferences;
b) a content classification component comprising a library storing content classifications and a storage storing textual content disaggregated into one or more content units based on said content classifications, wherein said textual content is identified based on said content preferences or user content selections associated with a client;
c) a content conversion component automatically converting said disaggregated content units into one or more audio files based on said audio preferences and said audio format preferences; and
d) a content delivery component delivering said one or more audio files to said client in (b) based on at least said delivery method preferences.

20. A central processing site to customize delivery of audio content to one or more clients, as per claim 19, wherein said content classification component further comprises:
a scan content providers component retrieving said textual content from said one or more content providers;
a disaggregate content component disaggregating said textual content into said one or more content units based on said content classifications; and
a user authentication component authenticating said one or more users to communicate with said content processing site.

21. A central processing site to customize delivery of audio content to one or more clients, as per claim 19, wherein said library stores information regarding sources of said textual content, said plurality of content providers and content types.

22. A central processing site to customize delivery of audio content to one or more clients, as per claim 21, wherein said content types store any of or a combination of the following: name and ID of said content type, enumeration of content fields, update frequency information, references to parent/child content types, and retrieval information.

23. A central processing site to customize delivery of audio content to one or more clients, as per claim 19, wherein said one or more content units stored in said storage store any of or a combination of the following: content unit ID, content type information, content date information, actual values of content, keyword search index, references to other content units, and time-to-live information.

24. A central processing site to customize delivery of audio content to one or more clients, as per claim 20, said user authentication component authenticates said one or more clients using any of the following methods: login/password, public/private key and biometric authentication.

25. A central processing site to customize delivery of audio content to one or more clients, as per claim 19, wherein said audio preferences comprise any of or a combination of the following: voice, pitch, tone, speed, volume and language.

26. A central processing site to customize delivery of audio content to one or more clients, as per claim 19, wherein said user preferences management component further stores delivery frequency preferences storing information regarding how often to deliver said one or more audio files and playback order preferences storing information regarding order in which said one or more files are to be delivered.

27. A central processing site to customize delivery of audio content to one or more clients, as per claim 19, wherein said delivery method preferences store information regarding how said one or more audio files are delivered to said client and information regarding a destination address of a device associated with said client, where said one or more audio files are to be delivered.

28. A central processing site to customize delivery of audio content to one or more clients, as per claim 27, wherein said information regarding how said one or more audio files are delivered comprises any of or a combination of: streaming mode, download mode, satellite radio mode, email mode, batch mode, scheduled transfer mode, and user-initiated transfer mode.

29. A central processing site to customize delivery of audio content to one or more clients, as per claim 27, wherein said information regarding a destination address comprises any of or a combination of the following: phone number, IP address, and satellite radio channel.

30. A central processing site to customize delivery of audio content to one or more clients, as per claim 19, wherein client sites associated with said one or more clients comprise a client browser component to interact with said central processing site, said client browser component comprising any of or a combination of the following: software browser, standard phone or cellular phone.

31. A central processing site to customize delivery of audio content to one or more clients, as per claim 30, wherein said software browser is any of the following: web-browser based application, web-enabled desktop application, command-line interface, or voice recognition interface.

32. A central processing site to customize delivery of audio content to one or more clients, as per claim 19, wherein client sites associated with said one or more clients comprise a playback system for a user to listen to said one or more audio files, said playback system comprising any of the following: PC/PDA audio devices/software, regular/cellular phone, satellite radio device, and browser capable of playing embedded audio objects.

33. A central processing site to customize delivery of audio content to one or more clients, as per claim 19, wherein said content conversion system comprises:
a text-to-speech translation component translating said disaggregated content units into said one or more audio files; and
a foreign language translation component automatically translating said disaggregated content units in one language into content units in another language, said content units in another language being passed to said text-to-speech translation component for conversion into said one or more audio files; and
an audio content storage storing said one or more audio files.

34. An article of manufacture comprising a computer readable medium having computer readable program code embodied therein which implements a method to customize delivery of audio content to one or more clients, said audio content derived from textual content obtained from one or more content providers, said medium comprising:
a. computer readable program code identifying textual content based on pre-stored content preferences or user content selections associated with a client;
b. computer readable program code aiding in receiving said identified textual content;
c. computer readable program code disaggregating said received textual content into one or more content units based on predefined content classification;
d. computer readable program code automatically converting said disaggregated content units into one or more audio files based on audio preferences and audio format preferences; and
e. computer readable program code aiding in delivering said one or more audio files to said client in (a) based on at least delivery method preferences.
